(19) United States
(12) Patent Application Publication
(10) Pub. No.: US 2019/0061143 A1
(43) Pub. Date: Feb. 28, 2019

(54) ROBOT ARM

(71) Applicants: Suryansh CHANDRA, London (GB); Mostafa ELSAYED, London (GB)

(72) Inventors: Suryansh CHANDRA, London (GB); Mostafa ELSAYED, London (GB)

(21) Appl. No.: 15/766,832

(22) PCT Filed: Oct. 7, 2016
(86) PCT No.: PCT/GB2016/053139

§ 371 Date: Apr. 9, 2018

(30) Foreign Application Priority Data
Oct. 9, 2015 (GB) 1517927.8
Oct. 9, 2015 (GB) 1517928.6
Oct. 9, 2015 (GB) 1517929.4

(51) Int. Cl. B25J 9/00; B25J 17/00; B25J 18/00

(52) U.S. Cl. CPC B25J 9/0012; B25J 18/00; B25J 17/00

(57) ABSTRACT

The present invention relates to a robotic arm (10) with five or more degrees of freedom of motion and comprising substantially load-bearing polymeric parts.

### FIELD

The present invention relates to robot arms. In particular, this invention relates to robot arms for industrial use that are substantially manufactured from polymeric materials.

### BACKGROUND

Industrial robots are automatically controlled, reprogrammable, multipurpose manipulators that are typically programmable in three or more axes. Typical applications can include moving objects, welding, painting, and product assembly and testing. Robots are advantageous where such applications require high endurance, precision or speed in comparison to the abilities of a human workforce.

Many industrial robots fall into the category of robot arms. Robot arms can be programmed to perform repetitive actions (without the variation that can occur when the same task is performed by a human). More advanced implementations of robot arms may involve the robot arm needing to assess tasks that it is programmed to perform, for example using forms of machine vision to determine the orientation of objects to be moved.

In a typical robotic arm, a number of segments are joined by joints to enable movement of the robotic arm. A computer controls the robotic arm by actuating a number of motors in the robotic arm such that the robotic arm performs a sequence of motions in order to complete a specific task.

An end-effector is provided at the end of the robot arm depending on the function of the robot arm, for example a gripper would be provided on robot arms that move objects. The end-effector is selected for the robot arm when it is being integrated into the industrial environment in which it operates, and configured when the robot arm is programmed for its desired task.

The number of axes in a robot arm defines the capabilities of the robot arm, so two axes are required to reach any point in two dimensions (i.e. a plane) and three axes are required to reach any point in three dimensions (i.e. free space). To allow the effector placed at the end of the robot arm to be controlled in orientation, a further three axes are required (yaw, pitch and roll). The number of axes usually correlates to the degrees of freedom available to the robot arm.

Typically, industrial robots are constructed from metal and made to a high degree of precision and with sufficient strength and tolerance for the weights of object that need to be manipulated. Industrial robot arms can be made from steel or cast iron load-bearing parts, built from the base up. A controller rotates motors that are attached at each joint but larger arms can use hydraulic and pneumatic means. This leads to their weight being significant and the cost of these robot arms to be high.

Further, the gearing needs to allow for high precision, in order to reduce or remove backlash in the gears. Backlash is the term given to the error in motion that occurs when gears change direction, the error being due to the gap between the faces of the driving and leading teeth of the meshed gears. Backlash is typically alleviated or removed in robot arms through the use of harmonic gears or other specially designed gears, but these are expensive.

### SUMMARY OF INVENTION

Aspects and/or embodiments can provide a method and/or system for a robot arm made substantially from polymeric materials that can reduce the weight of a robot arm in comparison with typical substantially metal-fabricated robot arms.

According to one aspect, there is provided a robotic arm with five or more degrees of freedom of motion and comprising substantially load-bearing polymeric parts.

Providing substantially load-bearing parts of a polymeric material can enable significant weight savings in comparison with a substantially metal robot arm.

Optionally, the polymeric parts are formed using a mass-manufacturing process. The polymeric parts may be formed by any one of: injection moulding; CNC machining, vacuum forming; and casting. These processes can provide low cost polymeric parts.

Optionally the polymeric parts are formed of an isotropic material. The polymeric parts may be formed of a homogenous polymer. Polymeric parts formed of isotropic materials, and in particular homogeneous polymers, can be easy and cheap to produce.

For versatility the robotic arm may have six or more degrees of freedom of motion. The robotic arm may have seven or more degrees of freedom of motion.

Optionally, the robotic arm may comprise a plurality of robotic arm segments with multiple segments (and preferably each segment) comprising substantially load-bearing polymeric parts. By providing multiple segments of substantially load-bearing polymeric parts a lightweight and cheap robotic arm can be provided.

Optionally, the casing of a plurality of robotic arm segments is composed of load-bearing polymeric parts.

By providing casing that acts as a load-bearing part of the robot arm, further or alternative structural support can be provided in the robot arm.

Optionally, the joint componentry joining the plurality of arm segments is composed of polymeric parts. Optionally, the joint componentry includes at least one of: gearing parts; drive transmission parts; and bearing parts.

By providing joint componentry in polymeric materials, significant weight savings can be achieved in comparison with a substantially metal robot arm.

Optionally, the maximum reach of the robotic arm is between 200 and 750 mm. Optionally, the maximum reach of the robotic arm is approximately 600 mm.

Providing a robot arm with a capability to reach between 200 mm and 750 mm, with a typical maximum reach of approximately 600 mm, allows the robot arm to operate within the typical range of a human's arm and thus suitable for replacing work performed manually by a human operator.

Optionally, the maximum payload of the robotic arm is between 0.3 and 3 kg. Optionally, the maximum payload of the robotic arm is between 0.3 and 2 kg. Optionally, the maximum payload of the robotic arm is approximately 0.75 kg. Optionally, the maximum payload of the robotic arm is approximately 1.5 kg.

Providing a robot arm with a capability to move payloads between 0.3 kg and 3 kg, with a typical maximum payload of 1.5 kg, allows the robot arm to operate within a typical range of jobs performed by a human and thus suitable for replacing work performed manually by a human operator, taking into account the weight of any end-effector.

Optionally, the maximum weight of the robotic arm is between 1 kg and 10 kg. Optionally, the maximum weight of the robotic arm is between 1 kg and 6 kg. Optionally, the maximum weight of the robotic arm is approximately 2.3 kg. Optionally, the maximum weight of the robotic arm is approximately 5 kg.

Providing a robot arm having a weight between 1 kg and 6 kg, with a typical maximum weight of 5 kg, allows the robot arm to be carried by a single person and increases flexibility in moving and re-deploying the robot arm.

Optionally, the load-bearing polymeric parts are composed of at least one of polyamide (PA) (also referred to as nylon) acrylonitrile butadiene styrene (ABS), poly lactid acid (PLA), copolymer acetal (POM-C), homopolymer acetal (POM-H), polybutylene terephthalate (PBT), liquid crystal polymer (LCP), thermoplastic elastomer (TPC-ET) and polyphthalamide (PPA),

Providing a variety of materials from which the polymeric parts can be fabricated provides flexibility in manufacture of a robot arm, for example taking into account weight, cost and strength.

Optionally, the load-bearing polymeric parts are between 1 and 15 mm thick. Optionally, the load-bearing polymeric parts are between 2 and 12 mm thick.

By providing parts with a thickness (a wall thickness) between 1 and 15 mm, and typically between 2 and 12 mm, significant weight savings can be achieved in comparison with a substantially metal robot arm.

Optionally, the load-bearing polymeric parts comprise ribbing.

Providing ribbing can increase the strength of the load-bearing polymeric parts.

Optionally, the load-bearing polymeric parts house functional componentry of the robotic arm. Optionally, the functional componentry includes at least one or more of: a data communication conduit; a power conduit; a pneumatic conduit; a drive transmission; a joint; and an actuator.

Providing functional componentry that is integrated in or into the load-bearing polymeric parts allows for more flexible integration of functionality into the robot arm and can avoid the need for extra parts that would add to the weight and complexity of the robot arm.

According to another aspect, there is provided a method of making a robotic arm as aforesaid or parts thereof of a polymeric material.

According to another aspect, there is provided a machine readable map, or machine readable instructions, configured to enable a 3D printer to manufacture a robotic arm as aforesaid or parts thereof of a polymeric material.

According to another aspect, there is provided a method of sending over a network a machine readable map, or machine readable instructions, configured to enable manufacture of a robotic arm as aforesaid or parts thereof of a polymeric material.

According to another aspect, there is provided a method of obtaining over a network a machine readable map, or machine readable instructions, configured to enable manufacture of a robotic arm as aforesaid or parts thereof of a polymeric material

According to another aspect, there is provided a computer program product configured to enable manufacture of a robotic arm as aforesaid or parts thereof of a polymeric material.

According to another aspect, there is provided a method of installing a plastic gear for use in a robot arm to reduce backlash comprising the steps of: selecting a larger diameter gear that has a larger diameter than the gear diameter required; installing the larger diameter gear; operating the robot arm to wear in the larger diameter gear such that the gear is subjected to a predetermined period of use in order to wear the gear such that it reduces in diameter.

Fitting a gear that has a larger diameter than the required diameter, but having a diameter which will still fit in place of the correct diameter gear, allows the gear to be worn in and it can then operate with reduced or negligible backlash.

Optionally, the reduction in diameter is substantially the same as the difference in diameter between the larger diameter gear and the gear diameter required.

Most of the diameter of the larger diameter gear can be worn away in order to leave a reduced diameter gear that can then operate with reduced or negligible backlash.

Optionally, the reduction in diameter is between 0.005% and 5%, or between 0.01% and 5%, or between 0.1% and 5%, or between 1% and 5%, or between 0.005% and 7.5% or between 0.005% and 10% or between 0.005% and 15%.

The initial diameter can be chosen so as not to cause the rest of the apparatus to break before being worn in and can be chosen so that the wearing-in process results in only an efficient amount of plastic to be worn away to result in the reduction in gear size.

Optionally, the difference in diameter between the larger diameter gear and the gear diameter required is substantially between 0.01 mm and 0.3 mm.

The excess diameter of between 0.05 mm and 0.3 mm can allow for an efficient reduction in gear size that does not waste a significant amount of plastic nor cause damage to the rest of the apparatus.

Optionally, the gear reduces in diameter by substantially 0.2 mm.

The reduction in diameter of substantially 0.2 mm can allow for an efficient reduction in gear size that does not waste a significant amount of plastic nor cause damage to the rest of the apparatus.

According to another aspect, there is provided a robotic arm as aforementioned including a gear installed according to a method as aforementioned.

According to another aspect, there is provided a rolling-element bearing comprising: a plurality of rolling elements; two side track parts; and at least one bearing cage wherein at least one of the side track parts are integrally formed in a casing; and wherein the plurality of rolling elements are operable to be provided between the two side track parts and the at least one bearing cage in use.

Providing a bearing where the side track part is integrated into a casing reduces the number of parts and therefore the resultant weight of an apparatus, especially where multiple such bearings are used.

Optionally, any or all of the plurality of rolling elements; the side track parts; or the at least one bearing cage are made from one or more polymers.

Providing a bearing made substantially or entirely from plastics materials (or other polymers) can further reduce the weight of an apparatus in which these are incorporated.

Optionally, the bearing is suitable for a robot arm.

Robot arms require a plurality of bearings thus any weight reduction can produce a significant aggregate reduction in apparatus weight.

Optionally, the casing is a part of a casing of the robot arm.

Robot arms can be provided with casing for functional and/or aesthetic purposes into which the bearing can partly be integrated, reducing the number of parts in the robot arm apparatus.

Optionally, the rolling-element bearing further comprises one or more rolling elements.

Typically a rolling-element bearing comprises one or more rolling elements, for example ball bearings.

Optionally, at least one of the side track parts is integrally formed with a load-bearing structure.

Integrating the bearing into a load-bearing structure can reduce the number of parts in an apparatus and can also provide a robust component to the bearing.

Optionally, the load-bearing structure is a load-bearing structure of the robot arm.

Robot arms have load-bearing parts into which the bearing can partly be integrated, reducing the number of parts in the robot arm apparatus.

Optionally, any or all of the bearing parts are composed of at least one of nylon, acrylonitrile butadiene styrene, and poly lactic acid.

Providing any or all of the bearing parts in a variety of materials can provide different strength to weight ratios among other characteristics, allowing flexibility in the design of an apparatus using an integrated bearing.

According to another aspect, there is provided casing comprising a side track part integrally formed in the casing for a rolling-element bearing as aforesaid.

According to another aspect, there is provided a robotic arm as aforementioned including a rolling-element bearing as aforementioned and optionally a casing as aforementioned.

Aspects and/or embodiments can also extend to methods and/or apparatus substantially as herein described with reference to the accompanying drawings.

Aspects and/or embodiments can also provide a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

Aspects and/or embodiments can also provide a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

Furthermore, features implemented in hardware may generally be implemented in software, and vice versa. Any reference to software and hardware features herein should be construed accordingly.

### BRIEF DESCRIPTION OF THE DRAWINGS

These and other aspects of the present invention will become apparent from the following exemplary embodiments that are described with reference to the following figures in which:

FIG. 1 is a perspective view of a robotic arm;

FIG. 2 is a side view of the robotic arm of FIG. 1 in different configurations;

FIG. 3 is a plan view of the robotic arm of FIG. 1 in different configurations;

FIG. 4 is an exploded perspective view of the robotic arm of FIG. 1;

FIG. 5 is a perspective view of a portion of the robotic arm of FIG. 1;

FIG. 6 is an exploded perspective view of a portion of the robotic arm of FIG. 1; and

FIG. 7 is a sectional side view of the portion of the robotic arm of FIG. 6.

### SPECIFIC DESCRIPTION

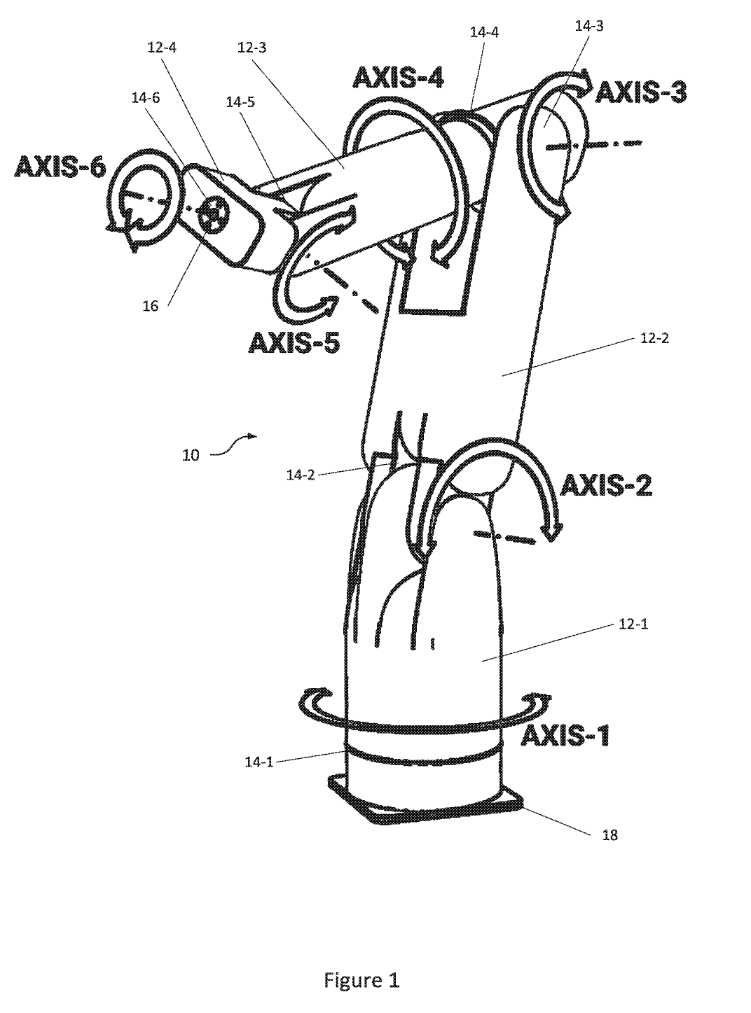

FIG. 1 shows a robotic arm 10 with six degrees of freedom. The robotic arm 10 is composed of four segments 12 attached to one another by three joints 14. Two of the segments 12-1 12-3 can rotate axially in addition to being rotatable about the joints 14. The last segment 12-4 (also referred to as the tool segment) has a tool interface 16 for fixing a tool to the robotic arm. The tool can be rotated in the segment axis. The first segment 12-1 (also referred to as the base segment) has a base portion 18 for fixing the robotic arm to a surface. The six degrees of freedom are indicated in FIG. 1 with arrows. With six degrees of freedom the robotic arm 10 can trace any desired trajectory with the tool interface 16 within the reach of the robotic arm 10. Additionally, a tool fixed to the robot arm can be guided to a destination with any desired orientation and the tool can be moved in space with six degrees of freedom (e.g. translation in 3 orthogonal directions and rotation around three orthogonal axes).

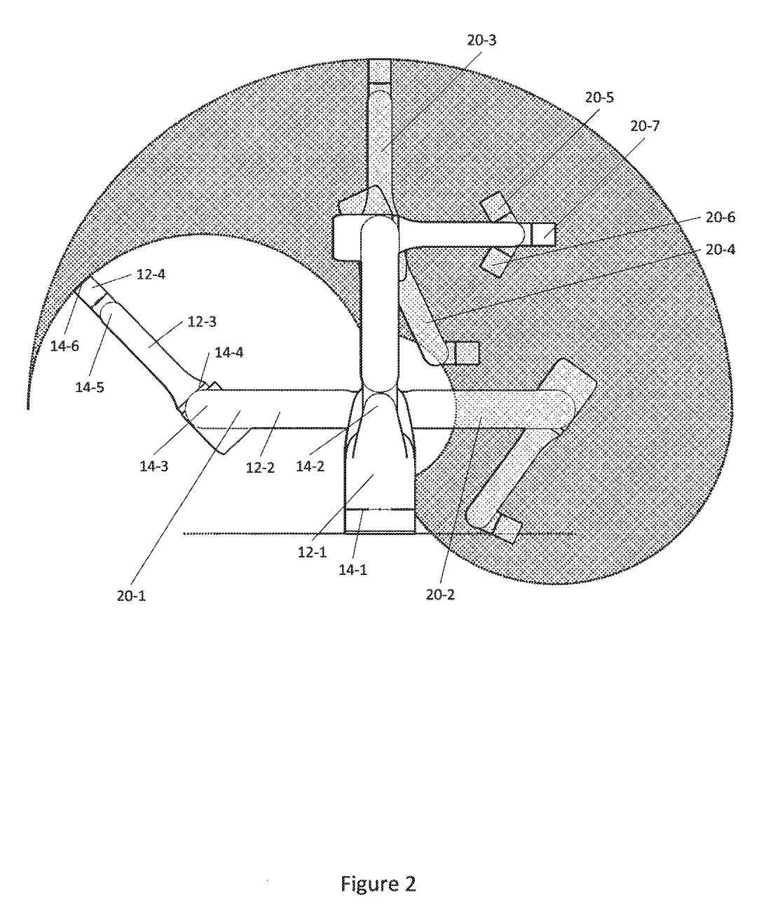

FIG. 2 shows a side view of the robotic arm 10 in seven different configurations 20 within a plane. Grey shading indicates the area that the robotic arm 10 can access within the maximum reach of the arm within that plane through rotation of the second joint 14-2, third joint 14-3 and fifth joint 14-5 alone. Two configurations 20-1 20-2 show the second segment 12-2 at either extreme that the second joint 14-2 permits, at 90° from vertical in either direction. Two configurations 20-3 20-4 show the third segment 12-3 at either extreme that the third joint 14-3 permits, in extension of the second segment 12-2 and at 155° from that extension. Two configurations 20-5 20-6 show the fourth segment 12-4 at either extreme that the fifth joint 14-5 permits, at 120° from the extension of the third segment 12-3 in either direction. One configuration 20-7 shows the fourth segment 12-4 in the extension of the third segment 12-3. The remaining first joint 14-1, fourth joint 14-4 and sixth joint 14-6 permit 360° of rotation about a segment axis: the first joint 14-1 in the axis of the first segment 12-1, the fourth joint 14-4 in the axis of the third segment 12-3 and the sixth joint 14-6 in the axis of the fourth segment 12-4.

One of the configurations 20-3 shows the arm 10 in maximum vertical extension. In this configuration 20-3 the reach is 600 mm from the axis of the first joint 14-1. The reach in this configuration 20-3 with the first segment included is 810 mm. The maximum horizontal reach is 600 mm from the axis of the first joint 14-1 in either direction. The maximum reach of the third and fourth segments 12-3 12-4 together (when in extension of one another) is 300 mm. In a variant a gantry, a mobile platform or a UAV (typically a stable flying platform such as a quadrocopter would be more suited to this augmentation) may be provided to extend the maximum reach of the robot arm.

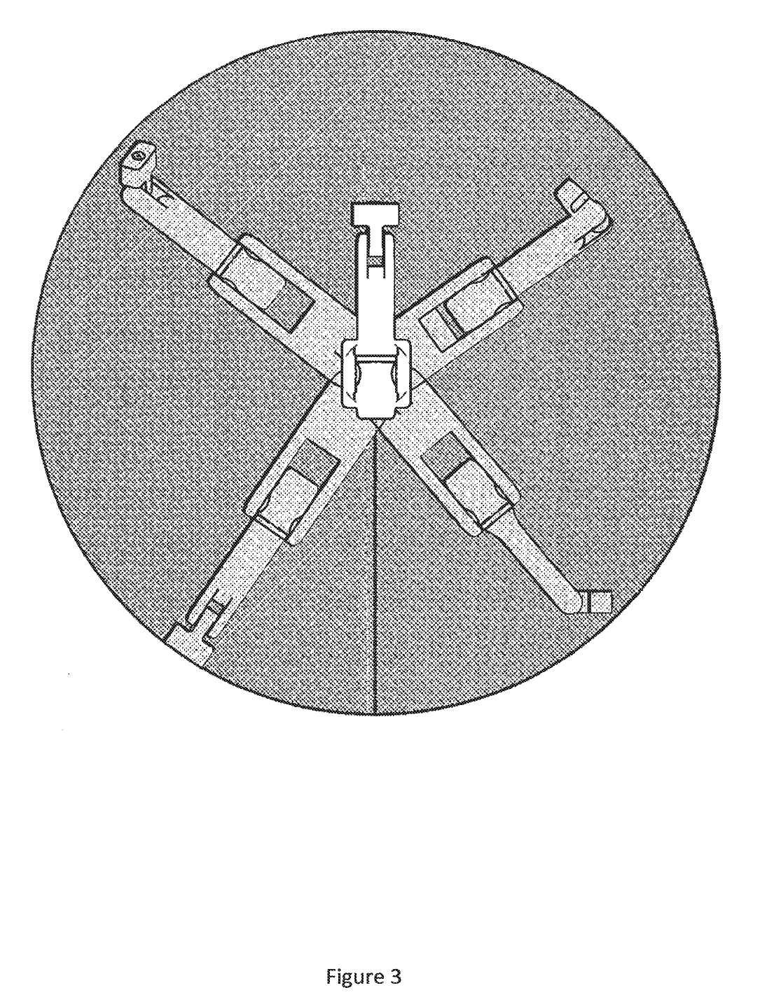

FIG. 3 shows a plan view of the robotic arm 10 in 5 different configurations 20 within a plane. Grey shading indicates the area that the robotic arm 10 can access within the maximum reach of the arm within that plane. The footprint of the arm is 120 mm by 120 mm. The base segment 12-1 can rotate 360° around a vertical axis.

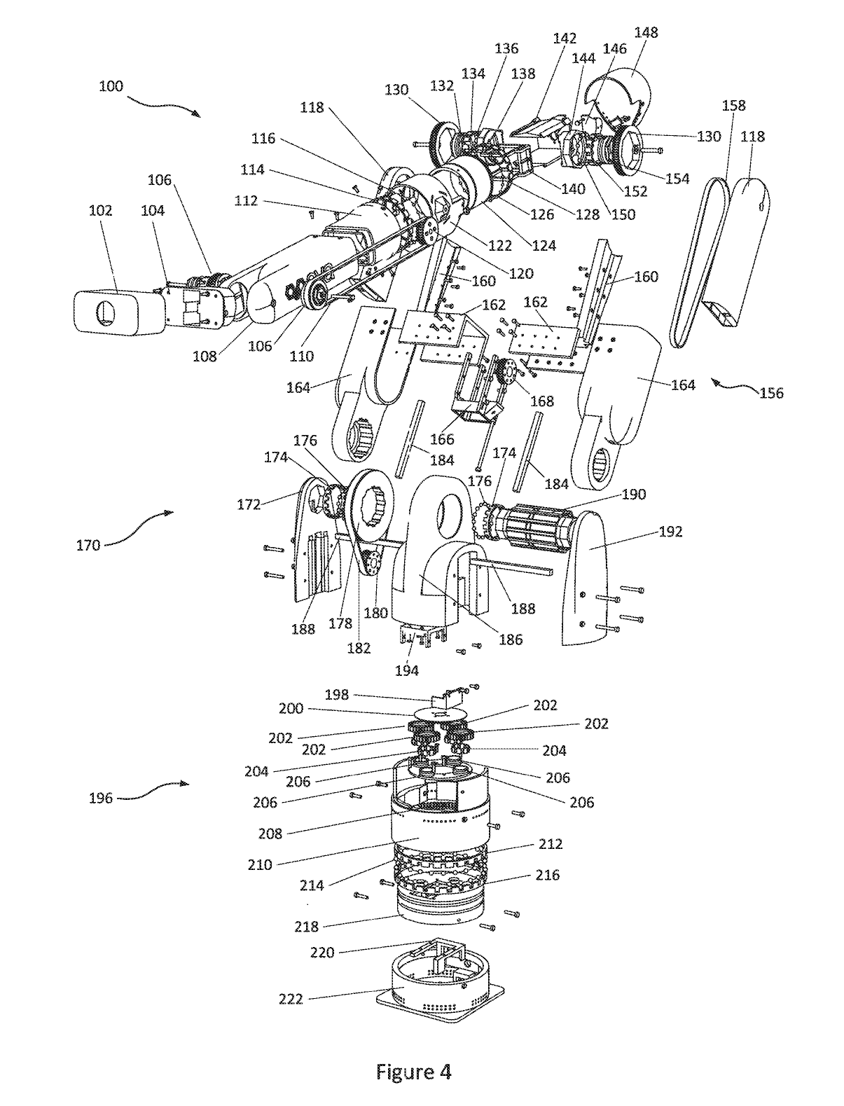

FIG. 4 shows an exploded perspective view of a robotic arm 100. The parts in FIG. 4 are:
100 Forearm
102 Wrist cover
104 Wrist attachment flange
106 Wrist articulation unit
108 Lower forearm shell/wrist attachment bracket
110 Wrist drive belt
112 Upper forearm shell
114 Lower forearm bearing cage
116 Lower forearm ball bearings
118 Elbow outer mounting bracket
120 Wrist driver pulley
122 Outer forearm shell with internal bearing raceway
124 Inner forearm shell (goes inside the outer shell and contains motor to drive forearm gear), with internal bearing raceway
126 Upper-forearm ball bearings
128 Upper-forearm bearing cage
130 Elbow pulley
132 Right elbow inner mounting bracket with internal bearing raceway
134 Right elbow bearing cage
136 Right elbow ball bearings
138 Right elbow gear attachment point with internal bearing raceway
140 Wrist motor mounting bracket
142 Wrist motor retainer
144 Left elbow gear insert
146 Wrist-twist motor mount
148 Elbow cap
150 Left elbow ball bearings
152 Left elbow bearing cage
154 Left elbow inner mounting bracket
156 Arm
158 Elbow drive belt
160 Shoulder stiffening flange
162 Shoulder attachment bracket
164 Upper arm shell
166 Elbow motor bracket
168 Elbow driver pulley
170 Shoulder
172 Right shoulder shell
174 Shoulder bearing cage
176 Shoulder ball bearings
178 Shoulder internal gear
180 Shoulder drive gear
182 Shoulder drive belt
184 Square cross section structural stiffeners
186 Shoulder joint mounting
188 Reinforcing rod for motor mount
190 Shoulder joint axle with internal bearing raceways
192 Left shoulder shell
194 Shoulder motor bracket (motor drives gear 180)
196 Waist
198 Shoulder motor lower mount
200 Combined cage retainer
202 Waist planetary gears with integrated bearing raceway
204 Waist planetary gear bearing cage and balls
206 Waist planetary gear retainer with integrated bearing raceway
208 Waist integrated planetary gear
210 Waist shell with integrated bearing raceway
212 Waist upper bearing cage
214 Waist ball bearings
216 Waist lower bearing cage
218 Waist motor mount with integrated bearing raceway
220 Waist motor bracket
222 Base unit with integrated microprocessor, microcontroller, switched-mode power supply

Within the robotic arm 6 motors are included to move the robotic arm as desired. The 6 motors are mounted at the wrist cover 102, the wrist motor mounting bracket 140, the wrist-twist motor mount 146, the elbow motor bracket 166, the shoulder motor bracket 194 and the waist motor bracket 220. The motors are of metal and the belts are of rubber, but all other parts are of plastics. Examples of plastics are nylon, acrylonitrile butadiene styrene, and poly lactid acid. Typical material performances of some representative plastics are:

### Nylon 66 HI (ST801) Such as Premier Plastic Resin Product Number PPR-6605HI

Tensile strength: 6800 psi/46.9 Mpa (ASTM test method D-638)
Elongation at break: 180% (ASTM test method D-638)
Flexural modulus: 245000 psi/1690 Mpa (ASTM test method D-790)
Flexural strength: 9500 psi/66 Mpa (ASTM test method D-790)
Izod impact: 18 ft-lb/in/960 J/m (ASTM test method D-256)
Melting point: 491° F./255° C. (ASTM test method D-3418)
Specific gravity: 1.08 (ASTM test method D-792)
Heat deflection temperature at 264 psi: 160° F./71° C. (ASTM test method D-648)

### ABS Low Gloss Natural Such as Premier Plastic Resin Product Number PPR-ABS04

Tensile strength: 6000 psi/41.4 Mpa (ASTM test method D-638)
Elongation at break: 35% (ASTM test method D-638)
Flexural modulus (tangent): 310000 psi/2140 Mpa (ASTM test method D-790)
Flexural strength: 10500 psi/72.4 Mpa (ASTM test method D-790)
Izod impact (notched): 2.7 ft-lb/in/140 J/m (ASTM test method D-256)
Specific gravity: 1.06 (ASTM test method D-792)
Melt flow rate (230° C./3800 g): 5 g/10 minutes (ASTM test method D-1238)
Heat deflection temperature at 264 psi: 185° F./85° C. (ASTM test method D-648)
Heat deflection temperature at 66 psi: 195° F./91° C. (ASTM test method D-648)
Linear mould shrinkage: 0.006 (ASTM test method D-955)

### Poly Lactic Acid Such as FKuR Kunstoff GmbH Product Number Bio-Flex® V 135001 (Trial Grade)

Modulus of elasticity: 2960 Mpa (ISO test method 527)
Tensile strength: 61.5 MPa (ISO test method 527)
Tensile strain at tensile strength: 5.3% (ISO test method 527)
Tensile stress at break: 38 MPa (ISO test method 527)
Tensile strain at break: 10.5% (ISO test method 527)
Flexural modulus: 3295 MPa (ISO test method 178)
Flexural strain at break: no break (ISO test method 178)
Flexural stress at 3.5% strain: 88.8 MPa (ISO test method 178)
Notched impact strength (Charpy), room temperature: 2.8 kJ/m² (ISO test method 179-1/1 eA)
Impact Strength (Charpy), room temperature: 30.8 kJ/m² (ISO test method 179-1/1 eA)
Density: 1.24 g/cm³ (ISO test method 1183)
Melting temperature: >155° C. (ISO test method 3146-C)
Melt flow rate (190° C./2.16 kg): 3-5 g/10 minutes (ISO test method 1133)

### DuPont Performance Polymers Delrin® 988PA NC010 Acetal (POM)

Tensile Strength, Yield: 72.0 MPa (ISO 527-1/-2)
Elongation at Yield: 12% (ISO 527-1/-2)
Tensile Modulus: 3.20 GPa (ISO 527-1/-2)
Flexural Modulus: 3.00 GPa (ISO 178)
Density: 1.42 g/cc (ISO 1183)
Melt Flow: 21 g/10 min at load 2.16 kg, temperature 190° C. (cm³/10 min; ISO 1133)
Melting Point: 178° C. (10° C./min; ISO 11357-1/-3)
Flammability, UL94: HB at thickness 0.800 mm (IEC 60695-11-10)

### Celanese Zenite® 7130 WT010 LCP

Specific Gravity: 1.65 g/cc (ASTM D 792)
Density: 1.67 g/cc (ISO 1183)
Filler Content: 30%
Linear Mold Shrinkage, Flow: −0.00100 cm/cm at thickness 15.7 mm; 0.00 cm/cm at thickness 3.17 mm (ASTM D955)
Linear Mold Shrinkage, Transverse: 0.0080 cm/cm at thickness 3.17 mm; 0.0090 cm/cm at thickness 1.60 mm (ASTM D955)
Hardness, Rockwell M: 63 (ASTM D 785)
Hardness, Rockwell R: 110 (ASTM D 785)
Tensile Strength at Break: 150 MPa (ISO 527)
Elongation at Break: 1.4% (ISO 527)
Tensile Modulus: 16.5 GPa (ISO 527)
Flexural Strength 210 MPa at temperature 23.0° C. (ISO 178)
Flexural Modulus: 13.0 GPa at temperature 23.0° C. (ISO 178)
Compressive Strength: 89.0 MPa (ASTM D 695)
Shear Strength: 57.0 MPa at thickness 0.800 mm; 58.0 MPa at thickness 3.17 mm (ASTM D732)
Izod Impact, Notched: 18.0 kJ/m² at temperature 23.0° C. (ISO 180/1A)
Izod Impact, Unnotched: 30.0 kJ/m² at temperature 23.0° C. (ISO 180/1U)
Charpy Impact, Unnotched: 3.00 J/cm² at temperature 23.0° C. (ISO 179/1eU)
Charpy Impact, Notched: 2.00 J/cm² at temperature 23.0° C. (ISO 179/1eA)
Volume Resistivity: 1.00e+16 ohm-cm (ASTM D 257)
Surface Resistance: 1.00e+15 ohm (ASTM D 257)
Dielectric Constant 3.5 at frequency 1.00e+6 Hz, temperature 23.0° C. 0.8 mm (ASTM D 150)
Melting Point: 352° C. (10° C./min; ISO 11357-1/-3)
Deflection Temperature at 1.8 MPa: 310° C. (ISO 75-1/-2 1993/N2)
Glass Transition Temp, Tg: 120° C. (ASTM D 3418)

### DuPont Performance Polymers Hytrel® 6356 TPC-ET

Density: 1.22 g/cc (ISO 1183)
Melt Density: 1.06 g/cc at temperature 230° C.
Water Absorption: 0.50% at time 24 hour (ASTM D 570); 0.60% at thickness 2.00 mm (similar to ISO 62)
Moisture Absorption: 0.200% at Thickness 2.00 mm (similar to ISO 62)
Linear Mold Shrinkage, Flow: 0.015 cm/cm (ISO 294-4, 2577)
Linear Mold Shrinkage, Transverse: 0.015 cm/cm (ISO 294-4, 2577)
Melt Flow: 9.0 g/10 min at load 2.16 kg, temperature 230° C. (ISO 1133)
Hardness, Shore D: <=63; 57 at time 15.0 sec (ISO 868)
Tensile Strength at Break: 43.0 MPa (ISO 527-1/-2)
Tensile Stress: 12.0 MPa at Strain 5.00%; 18.8 MPa at Strain 50.0%; 19.0 MPa at Strain 100% (ISO 527-1/-2)
Tensile Strength, Yield: 19.0 MPa (ISO 527-1/-2)
Elongation at Break: >=300%; 500% Nominal (ISO 527-1/-2)
Elongation at Yield: 33% (ISO 527-1/-2)
Tensile Modulus: 0.280 GPa (ISO 527-1/-2)
Flexural Modulus: 0.290 GPa (ISO 178)
Izod Impact, Notched: 81.0 kJ/m² at Temperature 23.0° C. (ISO 180/1A)
Charpy Impact, Notched: 12.0 J/cm² at Temperature 23.0° C. (ISO 179/1eA)
Impact: 300 at Temperature 23.0° C. (kJ/m² Tensile notched impact strength; ISO 8256/1)
Tensile Creep Modulus, 1 hour: 248 MPa (ISO 899-1)
Tensile Creep Modulus, 1000 hours: 182 MPa (ISO 899-1)
Tear Strength: 145 kN/m normal; 158 kN/m parallel (ISO 34-1)
Abrasion: 110 mm³ (ISO 4649)
Volume Resistivity: 8.00e+13 ohm-cm (IEC 60093)
Surface Resistance: >=1.00e+15 ohm (IEC 60093)
Dielectric Constant: 4.1 at Frequency 1.00e+6 Hz; 4.6 at Frequency 100 Hz (IEC 60250)
Dielectric Strength: 20.0 kV/mm (IEC 60243-1)
Dissipation Factor: 0.012 at Frequency 100 Hz (IEC 60250)
CTE, linear, Parallel to Flow: 178 μm/m-° C. (ISO 11359-1/-2)
CTE, linear, Transverse to Flow: 176 μm/m-° C. (ISO 11359-1/-2)
Specific Heat Capacity: 2.15 J/g-° C. (melt)
Thermal Conductivity: 0.150 W/m-K (Melt)
Melting Point: 210° C. (10° C./min; ISO 11357-1/-3)
Deflection Temperature at 0.46 MPa: 80.0° C. (ISO 75-1/-2)
Deflection Temperature at 1.8 MPa: 45.0° C. (ISO 75-1/-2)
Brittleness Temperature: −96.0° C. (ISO 974)
Glass Transition Temp, Tg: 0.000° C. (10° C./min; ISO 11357-1/-2)
   Polyphthalamide (PPA), 50% Glass Fiber Reinforced (Typical Values for Products from Different Providers)

| Physical Properties | Metric | Comments |
|---|---|---|
| Density | 1.55-1.99 g/cc | Average value: 1.64 g/cc Grade |
| | | Count: 60 |
| Filler Content | 45.0-50.0% | Average value: 47.8% Grade |
| | | Count: 39 |
| Water Absorption | 0.0200-3.60% | Average value: 0.567% Grade |
| | | Count: 18 |
| | 0.850-0.950% | Average value: 0.917% Grade |
| | @Temperature 70.0-70.0° C. | Count: 6 |
| Moisture Absorption at | 1.00-1.20% | Average value: 1.13% Grade |
| Equilibrium | | Count: 3 |
| Linear Mold Shrinkage | 0.000100-0.00600 cm/cm | Average value: 0.00249 cm/cm |
| | | Grade Count: 51 |
| Linear Mold Shrinkage, | 0.00100-0.0100 cm/cm | Average value: 0.00566 cm/cm |
| Transverse | | Grade Count: 33 |
| Mechanical Properties | Metric | Comments |
| Hardness, Rockwell R | 124-126 | Average value: 125 Grade |
| | | Count: 10 |
| Ball Indentation Hardness | 340-360 MPa | Average value: 353 MPa Grade |
| | | Count: 3 |
| Tensile Strength, Ultimate | 13.9-290 MPa | Average value: 199 MPa Grade |
| | | Count: 53 |
| | 60.0-225 MPa | Average value: 107 MPa Grade |
| | @Temperature 60.0-230° C. | Count: 5 |
| | 107-145 MPa | Average value: 107 MPa Grade |
| | @Temperature 130-180° C. | Count: 5 |
| | 107-145 MPa | Average value: 107 MPa Grade |
| | @Time 3.60e+6-7.20e+7 sec | Count: 5 |
| | 8.38-321.27 MPa | Average value: 107 MPa Grade |
| | @Strain 0.100-4.30% | Count: 3 |
| | 8.38-321.27 MPa | Average value: 107 MPa Grade |
| | @Temperature −40.0-150° C. | Count: 3 |
| Tensile Strength, Yield | 24.8-260 MPa | Average value: 211 MPa Grade |
| | | Count: 7 |
| Elongation at Break | 0.600-3.10% | Average value: 2.10% Grade |
| | | Count: 58 |
| | 2.00-7.20% | Average value: 4.29% Grade |
| | @Temperature 60.0-230° C. | Count: 5 |
| Modulus of Elasticity | 11.0-22.1 GPa | Average value: 17.1 GPa Grade |
| | | Count: 56 |
| | 1.10-17.0 GPa | Average value: 10.4 GPa Grade |
| | @Temperature 60.0-175° C. | Count: 5 |
| | 10.3-10.3 GPa | Average value: 10.4 GPa Grade |
| | @Temperature 135-135° C. | Count: 1 |
| | 10.3-10.3 GPa | Average value: 10.4 GPa Grade |
| | @Time 3.60e+6-3.60e+6 sec | Count: 1 |
| Flexural Yield Strength | 177-420 MPa | Average value: 332 MPa Grade |
| | | Count: 42 |
| | 94.5-267 MPa | Average value: 158 MPa Grade |
| | @Temperature 100-175° C. | Count: 1 |
| Flexural Modulus | 12.5-18.6 GPa | Average value: 15.5 GPa Grade |
| | | Count: 48 |
| | 4.90-13.0 GPa | Average value: 7.76 GPa Grade |
| | @Temperature 100-175° C. | Count: 1 |
| Compressive Yield | 159-314 MPa | Average value: 213 MPa Grade |
| Strength | | Count: 7 |
| Poissons Ratio | 0.380-0.410 | Average value: 0.398 Grade |
| | | Count: 6 |
| Shear Modulus | 0.350-4.00 GPa | Average value: 1.75 GPa Grade |
| | @Temperature 0.000-350° C. | Count: 3 |
| Shear Strength | 75.8-108 MPa | Average value: 91.3 MPa Grade |
| | | Count: 8 |
| Izod Impact, Notched | 0.590-4.97 J/cm | Average value: 1.36 J/cm Grade |
| | | Count: 25 |
| | 0.690-0.690 J/cm | Average value: 0.690 J/cm Grade |
| | @Temperature 135-135° C. | Count: 1 |
| | 0.690-0.690 J/cm | Average value: 0.690 J/cm Grade |
| | @Time 3.60e+6-3.60e+6 sec | Count: 1 |
| Izod Impact, Unnotched | 3.86-13.0 J/cm | Average value: 8.66 J/cm Grade |
| | | Count: 12 |
| Izod Impact, Notched | 7.80-100 kJ/m² | Average value: 16.1 kJ/m² Grade |
| (ISO) | | Count: 20 |
| | 11.0-13.5 kJ/m² | Average value: 12.5 kJ/m² Grade |
| | @Temperature −40.0-−20.0° C. | Count: 6 |
| Izod Impact, Unnotched | 61.0-87.0 kJ/m² | Average value: 74.0 kJ/m² Grade |
| (ISO) | | Count: 5 |
| Charpy Impact Unnotched | 1.00-9.50 J/cm² | Average value: 7.60 J/cm² Grade |
| | | Count: 25 |
| | 1.40-9.00 J/cm² | Average value: 6.55 J/cm² Grade |
| | @Temperature −30.0-−30.0° C. | Count: 8 |
| Charpy Impact, Notched | 0.200-9.00 J/cm² | Average value: 1.63 J/cm² Grade |
| | | Count: 32 |
| | 1.10-7.00 J/cm² | Average value: 2.14 J/cm² Grade |
| | @Temperature −40.0-−30.0° C. | Count: 11 |
| Tensile Creep Modulus, 1 | 10000-14000 MPa | Average value: 11700 MPa Grade |
| hour | | Count: 3 |
| Tensile Creep Modulus, | 7500-12000 MPa | Average value: 9170 MPa Grade |
| 1000 hours | | Count: 3 |
| Electrical Properties | Metric | Comments |
| Electrical Resistivity | 1.00e+11-1.00e+17 ohm-cm | Average value: 6.20e+15 ohm-cm |
| | | Grade Count: 23 |
| Surface Resistance | 1.00e+12-2.00e+15 ohm | Average value: 6.40e+14 ohm |
| | | Grade Count: 8 |
| Dielectric Constant | 3.40-6.10 | Average value: 4.30 Grade |
| | | Count: 17 |
| Dielectric Strength | 18.9-40.0 kV/mm | Average value: 25.5 kV/mm Grade |
| | | Count: 16 |
| Dissipation Factor | 0.00400-0.0500 | Average value: 0.0154 Grade |
| | | Count: 18 |
| Arc Resistance | 125-300 sec | Average value: 190 sec Grade |
| | | Count: 6 |
| Comparative Tracking | 325-600 V | Average value: 555 V Grade |
| Index | | Count: 22 |
| Hot Wire Ignition, HWI | 120-150 sec | Average value: 140 sec Grade |
| | | Count: 3 |
| High Amp Arc Ignition, | 60.0-120 arcs | Average value: 77.7 arcs Grade |
| HAI | | Count: 3 |
| High Voltage Arc-Tracking | 4.00-18.0 mm/min | Average value: 13.2 mm/min Grade |
| Rate, HVTR | | Count: 6 |
| Thermal Properties | Metric | Comments |
| CTE, linear | 12.0-500 μm/m-° C. | Average value: 104 μm/m-° C. Grade |
| | | Count: 15 |
| | 8.00-500 μm/m-° C. | Average value: 161 μm/m-° C. Grade |
| | @Temperature 55.0-250° C. | Count: 9 |
| CTE, linear, Transverse to | 36.0-76.0 μm/m-° C. | Average value: 53.5 μm/m-° C. |
| Flow | | Grade Count: 12 |
| | 53.0-150 μm/m-° C. | Average value: 96.4 μm/m-° C. |
| | @Temperature 55.0-250° C. | Grade Count: 8 |
| Melting Point | 260-327° C. | Average value: 309° C. Grade |
| | | Count: 34 |
| Maximum Service | 140-210° C. | Average value: 164° C. Grade |
| Temperature, Air | | Count: 7 |
| Deflection Temperature at | 120-320° C. | Average value: 270° C. Grade |
| 0.46 MPa (66 psi) | | Count: 20 |
| Deflection Temperature at | 90.0-302° C. | Average value: 268° C. Grade |
| 1.8 MPa (264 psi) | | Count: 51 |
| Deflection Temperature at | 205-250° C. | Average value: 229° C. Grade |
| 8.0 MPa | | Count: 4 |
| Vicat Softening Point | 100-295° C. | Average value: 241° C. Grade |
| | | Count: 5 |
| Glass Transition Temp, | 135-144° C. | Average value: 141° C. Grade |
| Tg | | Count: 3 |
| Flammability, UL94 | HB-V-0 | Grade Count: 32 |
| Flame Spread | 17.0-29.0 mm/min | Average value: 25.0 mm/min Grade |
| | | Count: 4 |
| Oxygen Index | 24.0-49.0% | Average value: 31.8% Grade |
| | | Count: 4 |
| Glow Wire Test | 700-960° C. | Average value: 836° C. Grade |
| | | Count: 3 |
| Processing Properties | Metric | Comments |
| Processing Temperature | 79.4-340° C. | Average value: 148° C. Grade |
| | | Count: 7 |
| Nozzle Temperature | 320-338° C. | Average value: 329° C. Grade |
| | | Count: 4 |
| Melt Temperature | 270-360° C. | Average value: 322° C. Grade |
| | | Count: 51 |
| Mold Temperature | 65.6-180° C. | Average value: 127° C. Grade |
| | | Count: 48 |
| Drying Temperature | 80.0-130° C. | Average value: 110° C. Grade |
| | | Count: 45 |
| Moisture Content | 0.0300-0.200% | Average value: 0.0803% Grade |
| | | Count: 37 |
| | 0.850-0.850% | Average value: 0.850% Grade |
| | @Temperature 70.0-70.0° C. | Count: 2 |
| Dew Point | −31.7-−28.9° C. | Average value: −30.1° C. Grade |
| | | Count: 7 |
| Injection Pressure | 41.4-124 MPa | Average value: 88.2 MPa Grade |
| | | Count: 9 |

### Celanese THERMX LED 0201 PCT, 40% Specialty

| Physical Properties | Metric | Comments |
|---|---|---|
| Density | 1.62 g/cc | ISO 1183 |
| Linear Mold Shrinkage, | 0.0030 cm/cm | ISO 294-4 |
| Flow | | |
| Linear Mold Shrinkage, | 0.0090 cm/cm | ISO 294-4 |
| Transverse | | |
| Mechanical Properties | Metric | Comments |
| Tensile Strength at Break | 73.0 MPa | 5 mm/min; |
| | | ISO 527-2/1A |
| Elongation at Break | 1.7% | 5 mm/min; |
| | | ISO 527-2/1A |
| Tensile Modulus | 6.27 GPa | 50 mm/min; |
| | | ISO 527-2/1A |
| Charpy Impact | 3.20 J/cm² | ISO 179/1eU |
| Unnotched | | |
| Charpy Impact, Notched | 0.320 J/cm² | ISO 179/1eA |
| Thermal Properties | Metric | Comments |
| CTE, linear, Parallel to | 32.0 μm/m-° C. | ISO 11359-2 |
| Flow | | |
| CTE, linear, Transverse to | 102 μm/m-° C. | ISO 11359-2 |
| Flow | | |
| Melting Point | 285° C. | 10° C/min; |
| | | ISO 11357-1,-2,-3 |
| Processing Properties | Metric | Comments |
| Processing Temperature | 100-150° C. | cavity |
| Zone 1 | 290-305° C | |
| Zone 2 | 285-300° C. | |
| Zone 3 | 285-300° C. | |
| Zone 4 | 285-300° C. | |
| Die Temperature | 285-295° C. | |
| Melt Temperature | 290-310° C. | |
| Drying Temperature | 95.0-100° C. | |
| Dry Time | 4.00-6.00 hour | |
| Moisture Content | ≤0.030% | |

### DuPont Crastin FG6129 NC010 PBT

| Physical Properties | Metric | Comments |
|---|---|---|
| Density | 1.30 g/cc | ISO 1183 |
| Melt Density | 1.12 g/cc | |
| | @Temperature 250° C. | |
| Water Absorption | 0.40% | Sim. to ISO 62 |
| | @Thickness 2.00 mm | |
| Moisture Absorption | 0.200% | Sim. to ISO 62 |
| | @Thickness 2.00 mm | |
| Viscosity Test | 150 cm³/g | Viscosity number; |
| | | ISO 307, 1157, 1628 |
| Linear Mold Shrinkage, | 0.017 cm/cm | ISO 294-4, 2577 |
| Flow | | |
| Linear Mold Shrinkage, | 0.015 cm/cm | ISO 294-4, 2577 |
| Transverse | | |
| Melt Flow | 10 g/10 min | ISO 1133 |
| | @Load 2.16 kg, | |
| | Temperature 250° C. | |
| Mechanical Properties | Metric | Comments |
| Tensile Strength, Yield | 58.0 MPa | ISO 527-1/-2 |
| Elongation at Break | ≥50% | Nominal; |
| | | ISO 527-1/-2 |
| Elongation at Yield | 5.0% | ISO 527-1/-2 |
| Tensile Modulus | 2.60 GPa | ISO 527-1/-2 |
| Flexural Strength | 85.0 MPa | ISO 178 |
| Flexural Modulus | 2.35 GPa | ISO 178 |
| Izod Impact, Notched | 4.50 kJ/m² | ISO 180/1A |
| (ISO) | @Temperature 23.0° C. | |
| | 6.00 kJ/m² | ISO 180/1A |
| | @Temperature −30.0° C. | |
| Izod Impact, Unnotched | 130 kJ/m² | ISO 180/1U |
| (ISO) | @Temperature -30.0° C. | |
| | NB | ISO 180/1U |
| | @Temperature 23.0° C. | |
| Charpy Impact | NB | ISO 179/1eU |
| Unnotched | @Temperature 23.0° C. | |
| | NB | ISO 179/1eU |
| | @Temperature −30.0° C. | |
| Charpy Impact, Notched | 0.400 J/cm² | ISO 179/1eA |
| | @Temperature −30.0° C. | |
| | 0.550 J/cm² | ISO 179/1eA |
| | @Temperature 23.0° C. | |
| Tensile Creep Modulus, 1 | 2600 MPa | ISO 899-1 |
| hour | | |
| Tensile Creep Modulus, | 1800 MPa | ISO 899-1 |
| 1000 hours | | |
| Electrical Properties | Metric | Comments |
| Volume Resistivity | ≥1.00e+15 ohm-cm | IEC 60093 |
| Surface Resistance | 1.00e+12 ohm | IEC 60093 |
| Dielectric Strength | 26.0 kV/mm | IEC 60243-1 |
| Comparative Tracking | 600 V | IEC 60112 |
| Index | | |
| Thermal Properties | Metric | Comments |
| CTE, linear, Parallel to | 130 μm/m-° C. | ISO 11359-1/-2 |
| Flow | | |
| CTE, linear, Transverse to | 130 μ/m-° C. | ISO 11359-1/-2 |
| Flow | | |
| Specific Heat Capacity | 2.09 J/g-° C. | melt |
| Thermal Conductivity | 0.250 W/m-K | Melt |
| Melting Point | 225° C. | 10° C./min; |
| | | ISO 11357-1/-3 |
| Deflection Temperature at | 115° C. | ISO 75-1/-2 |
| 0.46 MPa (66 psi) | | |
| | 180° C. | Annealed; |
| | | ISO 75-1/-2 |
| Deflection Temperature at | 50.0° C. | ISO 75-1/-2 |
| 1.8 MPa (264 psi) | | |
| | 60.0° C. | ISO 75-1/-2 |
| Vicat Softening Point | 175° C. | 50° C./h, 50N; |
| | | ISO 306 |
| Flammability, UL94 | HB | IEC 60695-11-10 |
| | @Thickness 1.50 mm | |
| | HB | IEC 60695-11-10 |
| | @Thickness 0.900 mm | |
| Oxygen Index | 22% | ISO 4589-1/-2 |
| Processing Properties | Metric | Comments |
| Melt Temperature | ≥240° C. | |
| | 250° C. | Optimum |
| | ≤260° C. | |
| Mold Temperature | ≥30.0° C. | |
| | 80.0° C. | Optimum |
| | ≤130° C. | |
| Ejection Temperature | 170° C. | |
| Drying Temperature | 110° C. | |
| | @Time 7200-14400 sec | |
| | 120° C. | |
| | @Time 7200-14400 sec | |
| | 130° C. | |
| | @Time 7200-14400 sec | |
| Moisture Content | 0.040% | |
| Hold Pressure | 60.0 MPa | |

### DuPont Performance Polymers Zytel® HTN54G35HSLR NC010 PA-IGF35

| Physical Properties | Metric | Comments |
|---|---|---|
| Density | 1.42 g/cc | DAM; ISO 1183 |
| Linear Mold Shrinkage, | 0.0020 cm/cm | DAM; ISO 294-4, 2577 |
| Flow | | |
| | 0.0060 cm/cm | DAM; ISO 294-4, 2577 |
| Mechanical Properties | Metric | Comments |
| Tensile Strength at Break | 180 MPa | DAM; ISO 527-1/-2 |
| Elongation at Break | 3.0% | DAM; ISO 527-1/-2 |
| Tensile Modulus | 10.0 GPa | DAM; ISO 527-1/-2 |
| Flexural Modulus | 9.00 GPa | DAM; ISO 178 |
| Poissons Ratio | 0.38 | DAM; ISO 527-1/-2 |
| Charpy Impact | 7.50 J/cm² | DAM; ISO 179/1eU |
| Unnotched | @Temperature | |
| | 23.0° C. | |
| Charpy Impact, Notched | 0.900 J/cm² | DAM; ISO 179/1eA |
| | @Temperature | |
| | −40.0° C. | |
| | 1.10 J/cm² | 50% RH; ISO 179/1eA |
| | @Temperature | |
| | 23.0° C. | |
| | 1.20 J/cm² | DAM; ISO 179/1eA |
| | @Temperature | |
| | 23.0° C. | |
| Tensile Creep Modulus, 1 | 11000 MPa | 50% RH; ISO 899-1 |
| hour | | |
| Tensile Creep Modulus, | 10000 MPa | 50% RH; ISO 899-1 |
| 1000 hours | | |
| Electrical Properties | Metric | Comments |
| Surface Resistance | 1.00e+14 ohm | 50% RH; IEC 60093 |
| Dielectric Strength | 42.0 kV/mm | 50% RH; IEC 60243-1 |
| | 43.0 kV/mm | DAM; IEC 60243-1 |
| Comparative Tracking | 600 V | DAM; IEC 60112 |
| Index | | |
| Thermal Properties | Metric | Comments |
| CTE, linear, Parallel to | 20.0 μm/m-° C. | DAM; ISO 11359-1/-2 |
| Flow | | |
| | 20.0 μm/m-° C. | DAM; ISO 11359-1/-2 |
| | @Temperature | |
| | −40.0-23.0° C. | |
| CTE, linear, Transverse to | 72.0 μm/m-° C. | DAM; ISO 11359-1/-2 |
| Flow | | |
| | 75.0 μm/m-° C. | DAM; ISO 11359-1/-2 |
| | @Temperature | |
| | −40.0-23.0° C. | |
| Thermal Conductivity | 0.350 W/m-K | Solid |
| Melting Point | 300° C. | first heat; DAM; |
| | | ISO 11357-1/-3 |
| Deflection Temperature at | 285° C. | DAM; ISO 75-1/-2 |
| 0.46 MPa (66 psi) | | |
| Deflection Temperature at | 255° C. | DAM; ISO 75-1/-2 |
| 1.8 MPa (264 psi) | | |
| Processing Properties | Metric | Comments |
| Melt Temperature | ≥320° C. | |
| | 325° C. | Optimum |
| | ≤330° C. | |
| Mold Temperature | ≥85° C. | |
| | ≤135° C. | |
| Drying Temperature | 100° C. | |
| | @Time | |
| | 21600-28800 sec | |
| Moisture Content | 0.10% | |

Some of the above specified plastics are suitable for 3D printing or injection moulding as fabrication methods. Some of the parts may be generic parts that are readily obtainable (such as the motors and screws and belts) and others may be manufactured specifically for the robot arm (casing parts such as the shell parts and covers and caps; drive transmission parts such as gear parts and pulley parts; bearing parts; strengthening parts such as flanges and brackets; and mounting parts such as retainers and mounts). By providing most of the parts of the robot arm in plastic an overall weight of 2 to 6 kg can be achieved for the example described above, and typically approximately 5 kg. By providing most of the parts of the robot arm in plastic the cost of a robotic arm can be kept relatively low.

The robotic arm may be manufactured by assembling pre-manufactured components such as polymeric plates which may be glued or otherwise bonded together. Other methods of manufacture may also be used. For example, the robotic arm (or parts thereof) may be manufactured by way of ‘3D printing’ whereby a three-dimensional model of the robotic arm (or parts thereof) is supplied, in machine readable form, to a ‘3D printer’ adapted to manufacture the robotic arm (or parts thereof). This may be by additive means such as extrusion deposition, Electron Beam Freeform Fabrication (EBF), granular materials binding, lamination, photopolymerization, or stereolithography or a combination thereof. The machine readable model comprises a spatial map of the object to be printed, typically in the form of a Cartesian coordinate system defining the object's surfaces. This spatial map may comprise a computer file which may be provided in any one of a number of file conventions. One example of a file convention is a STL (STereoLithography) file which may be in the form of ASCII (American Standard Code for Information Interchange) or binary and specifies areas by way of triangulated surfaces with defined normals and vertices. An alternative file format is AMF (Additive Manufacturing File) which provides the facility to specify the material and texture of each surface as well as allowing for curved triangulated surfaces. The mapping of the robotic arm (or parts thereof) may then be converted into instructions to be executed by 3D printer according to the printing method being used. This may comprise splitting the model into slices (for example, each slice corresponding to an x-y plane, with successive layers building the z dimension) and encoding each slice into a series of instructions. The instructions sent to the 3D printer may comprise Numerical Control (NC) or Computer NC (CNC) instructions, preferably in the form of G-code (also called RS-274), which comprises a series of instructions regarding how the 3D printer should act. The instructions vary depending on the type of 3D printer being used, but in the example of a moving printhead the instructions include: how the printhead should move, when/where to deposit material, the type of material to be deposited, and the flow rate of the deposited material.

The robotic arm (or parts thereof) as described herein may be embodied in one such machine readable model, for example a machine readable map or instructions, for example to enable a physical representation of said robotic arm (or parts thereof) to be produced by 3D printing. This may be in the form of a software code mapping of the robotic arm (or parts thereof) and/or instructions to be supplied to a 3D printer (for example numerical code).

To give sufficient strength to the robotic arm where it is substantially made of plastic, internal brackets may be designed to strengthen certain portions of the arm. Ribbing may be integrated in the casing parts to increase the strength. The wall thickness may be up to 12 mm in parts that require extra strength, such as the base. Parts that require less strength (such as the tool segment) may be thinner, for example as thin as 2 mm.

The maximum payload of the robotic arm made of plastic and dimensioned as described above is in the range of 0.3 to 3.0 kg, and typically 0.5 to 2.0 kg or approximately 1.5 kg.

The robot arm may be mounted at the base 18 to a table, wall, ceiling or an inclined surface. At or near the base a data port is provided for connection of the robot arm to a controller such as a suitably programmed computer. The data port may for example be a USB 2.0/3.0/4.0 port, CAN port or a wireless connection port. At or near the base a power port is provided for supplying power to the motors in the robotic arm. A typical power requirement of the motors may be DC 24V 10A; the base may include a switched-mode power supply to ensure the motors are provided with suitable power.

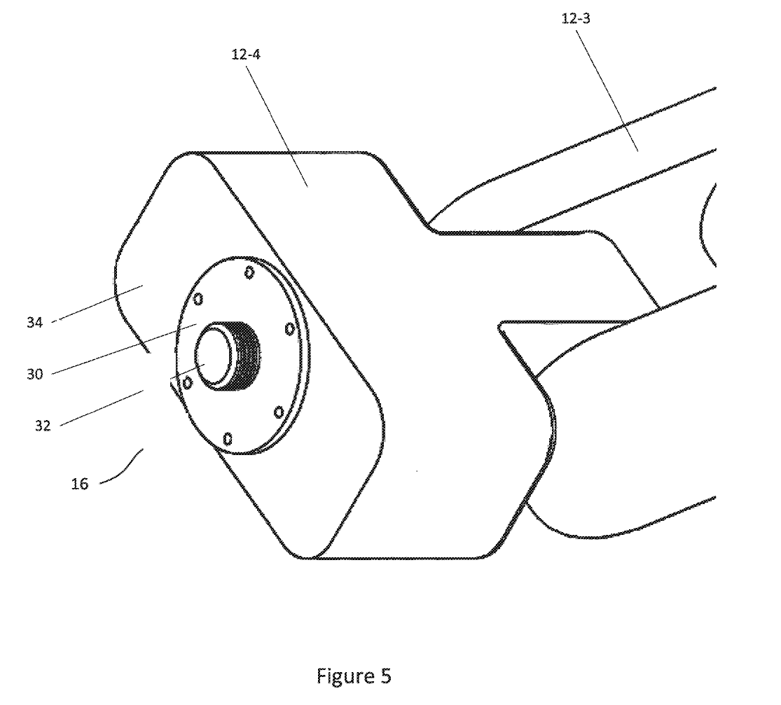

FIG. 5 shows the tool interface 16 in more detail. The tool interface 16 is presented at the end of the tool segment 12-4. The tool segment 12-4 presents a surface 34 into which the interfacing components are embedded. The surface 34 is approximately 80 mm by 40 mm. The surface 34 can help stabilise a tool attachment to the robotic arm.

The interfacing components embedded in the surface 34 include an electronically controllable tool attachment 30. The attachment 30 serves to physically affix a tool to the tool segment 12-4. In the illustrated example the attachment 30 is disc-shaped with approximately 38 mm outer diameter and embedded in the centre of the surface 34. In the illustrated example the electronically controllable tool attachment 30 can be an electromagnetic attachment where a permanent magnet presented by a tool is either attracted to the interface 16 and affixed there, or not, depending on electric actuation of the electromagnetic attachment. By enabling electronically controllable tool attachment the robot arm can be controlled to exchange tools without requiring any human assistance. This can widen the scope of tasks a robot arm can perform and hence increase its usefulness.

The interfacing components also include ports such as a data port, a power port and a pressure port. In the illustrated example a data and power port are combined in a circular male connector 32, and the tool presents a connectable female port that can be mated for connection. In the illustrated example the connector 32 for the data and power port is cylindrical with approximately 15 mm diameter and 8 mm height (and the corresponding female connector on the tool is similarly cylindrical) such that angular orientation of a tool about the connection axis does not affect the connection. This can allow attachment of a tool in an arbitrary angular orientation. This is convenient for a tool such as a screw head attachment, where a specific axial orientation of the tool is not crucial. For other tools such as a mechanical gripper the tool can include a sensor (such as a gyroscope) for sensing tool orientation; following attachment of the tool to the robotic arm the tool orientation is determined and the tool rotated by the robot arm in the connection axis to a desired angular orientation of the tool. By permitting attachment of a tool in an arbitrary angular orientation the exchange of tools by the robotic arm is facilitated and lower dependence on human assistance can be enabled.

Some examples of tools are a mechanical gripper; a pneumatic gripper; a screw head attachment; and a machine specific attachment (such as a claw designed to fit into a handle of a particular device the robotic arm is to manipulate). In order to identify a tool each tool can have an identification that can be transmitted to the robot arm and controller via a data connection. The controller can then identify the tool. The software for controlling the robot arm allows for tool identifiers (universal global unique identifiers) to enable this.

In an alternative example the electronically controllable tool attachment 30 is not an electromagnetic attachment but an interlocking attachment that is electronically controllable, for example with a disc-shaped orifice that can receive a disc-shaped protrusion of a tool and a number or electronically controllable catches that clamp the protrusion in the orifice. The electronically controllable catches may be pneumatically actuated or electrically actuated, for example.

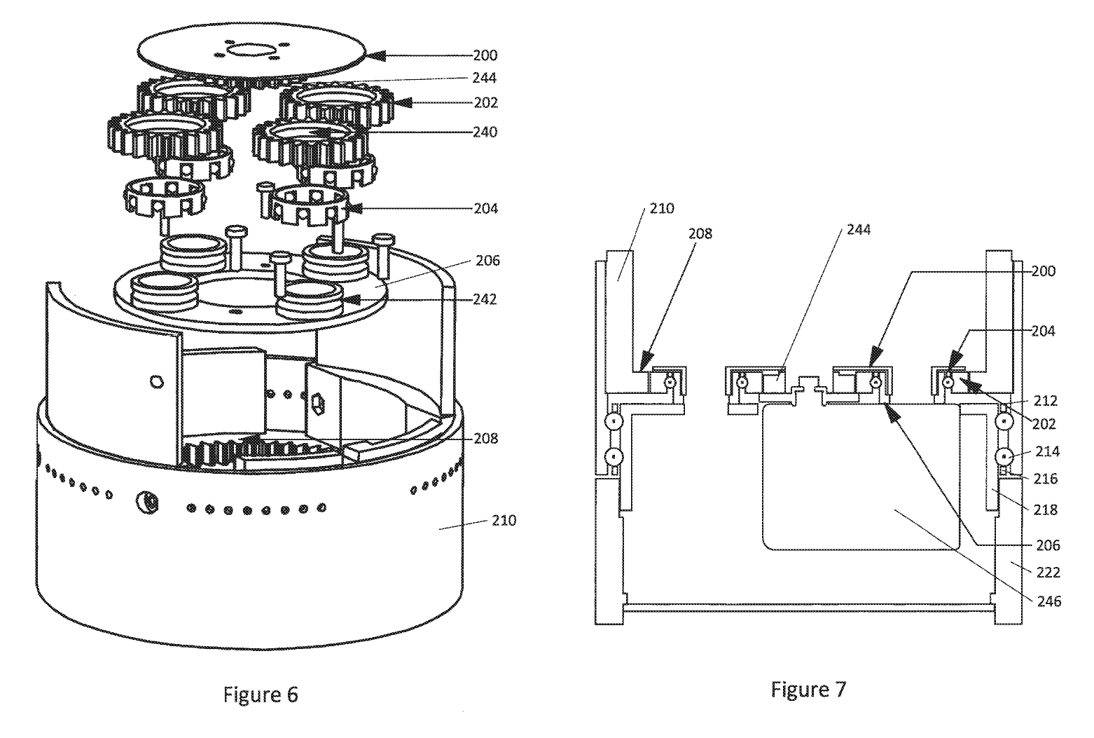

FIGS. 6 and 7 show the base segment 12-1 of the robotic arm in more detail. The waist integrated planetary gear 208 is integrated into the internal circumference of the waist shell 210. The waist integrated planetary gear 208 meshes with four waist planetary gears 202. Each of the four waist planetary gears 202 has a bearing outer raceway 240 integrated into the internal circumference of the gear 202. Bearings are contained by a bearing cage 204. A bearings inner raceway 242 is integrated in a waist planetary gear retainer 206. The four bearing cages 204 are held in place by a combined cage retainer 200. A waist drive gear ring 244 that is attached to a drive motor 246 meshes with the four waist planetary gears 202.

Each bearing is composed of three parts: a plurality of rolling elements, two side track (or raceway) parts and a bearing cage (spacer). The two track parts are integrated into the casing of the robot, so each track is fabricated simultaneously with the casing part it is integrated within. The bearing cage is inserted separately.

The gears 202 208 244 shown in FIGS. 6 and 7 are of a polymer. Conventionally polymers are not selected for gears where a non-negligible torque is transmitted as polymers can deform under strain. The consequence of such a deformation is backlash in the gearing, causing unintended motion of the robot arm. Backlash occurs in particular when the gears change direction, because of existing gaps between the trailing face of the driving tooth and the leading face of the tooth behind it on the driven gear. In order to provide the gears in plastic for inexpensive and lightweight parts for a robot while avoiding problems with backlash the gears are sized larger than an ordinary gear meshing would dictate. Plastic gears are designed with a 0.05 mm to 0.3 mm increase in size relative to a conventional ‘just touching’ dimension choice. During initial operation the slightly oversized plastic gears are worn in by forcing their operation despite the gear meshing being excessively compressed. The selection of a planetary gear is favourable for the wearing in period as the gear axes are not subject to undue shear stress due to the oversizing. A wearing in period may for example be a few hours of operation. Following wearing in of such oversized plastic gearing repeatability of tool positioning in the range of 0.05 to 2 mm can be achieved, and typically 0.2 to 1 mm repeatability can be achieved.

The precise optimum size increase depends on the stiffness of a material, and may be greater for a very soft material or smaller for a very stiff material. Typically both gears are oversized by the same amount, even if the diameters of the gears are not the same. In an example a first gear with a nominal 1000.0 mm diameter meshes with a second gear with a nominal 10.0 mm diameter. The first gear is oversized to 1000.2 mm, and the second gear is oversized to 10.2 mm.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

What is claimed is:

1. A robotic arm with five or more degrees of freedom of motion and comprising substantially load-bearing polymeric parts.

2. A robotic arm according to claim 1 wherein the polymeric parts are formed using a mass-manufacturing process.

3. A robotic arm according to any of claim 1 or 2 wherein the polymeric parts are formed by any one of: injection moulding; CNC machining, vacuum forming; and casting.

4. A robotic arm according to any preceding claim wherein the polymeric parts are formed of an isotropic material.

5. A robotic arm according to any preceding claim wherein the polymeric parts are formed of a homogenous polymer.

6. A robotic arm according to any preceding claim with six or more degrees of freedom of motion.

7. A robotic arm according to any preceding claim with seven or more degrees of freedom of motion.

8. A robotic arm according to any preceding claim comprising a plurality of robotic arm segments with each segment comprising substantially load-bearing polymeric parts.

9. A robotic arm according to claim 8 wherein the casing of the plurality of robotic arm segments is composed of load-bearing polymeric parts.

10. A robotic arm according to claim 9 wherein the joint componentry joining the plurality of arm segments is composed of polymeric parts.

11. A robotic arm according to claim 10 wherein the joint componentry includes at least one of: gearing parts; drive transmission parts; and bearing parts.

12. A robotic arm according to any preceding claim wherein the maximum reach of the robotic arm is between 200 and 750 mm.

13. A robotic arm according to claim 12, wherein the maximum reach of the robotic arm is approximately 600 mm.

14. A robotic arm according to any preceding claim wherein the maximum payload of the robotic arm is between 0.3 and 3 kg.

15. A robotic arm according to claim 14, wherein the maximum payload of the robotic arm is approximately 1.5 kg.

16. A robotic arm according to any preceding claim wherein the maximum weight of the robotic arm is between 1 kg and 6 kg.

17. A robotic arm according to claim 16, wherein the maximum weight of the robotic arm is approximately 5 kg.

18. A robotic arm according to any preceding claim, wherein the load-bearing polymeric parts are composed of at least one of polyamide, acrylonitrile butadiene styrene, poly lactid acid, copolymer acetal, homopolymer acetal, polybutylene terephthalate, liquid crystal polymer, thermoplastic elastomer and polyphthalamide.

19. A robotic arm according to any preceding claim, wherein the load-bearing polymeric parts are between 1 and 15 mm thick.

20. A robotic arm according to any preceding claim, wherein the load-bearing polymeric parts are between 2 and 12 mm thick.

21. A robotic arm according to any preceding claim, wherein the load-bearing polymeric parts comprise ribbing.

22. A robotic arm according to any preceding claim, wherein the load-bearing polymeric parts house functional componentry of the robotic arm.

23. A robotic arm according to claim 22, wherein the functional componentry includes at least one of: a data communication conduit; a power conduit; a pneumatic conduit; a drive transmission; a joint; and an actuator.

24. A method of making a robotic arm according to any preceding claim made of a polymeric material.

25. A robotic arm substantially as herein described and/or as illustrated with reference to the accompanying figures.
